(19) United States
(12) Patent Application Publication
(10) Pub. No.: US 2007/0146819 A1
(43) Pub. Date: Jun. 28, 2007

(54) Scanner control medium, scanner control device, and scanner device

(75) Inventor: Takafumi Kai, Nagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/645,611

(22) Filed: Dec. 27, 2006

(30) Foreign Application Priority Data
Dec. 27, 2005 (JP) P2005-375593

(51) Int. Cl. H04N 1/04

(52) U.S. Cl. 358/474; 358/453

(57) ABSTRACT

A computer-usable medium comprises instructions that cause a computer to serve as a scanner control device comprising a first scanning system that makes a scanner perform first scanning of an original with a first resolution, a display system that displays a pre-scanned image by the first scanning, an area specifying frame displaying system that displays an area specifying frame rotated by a specified rotation angle, an area specifying system that specifies an area of an image to be acquired on the pre-scanned image with the area specifying frame, a second scanning system that makes the scanner perform second scanning of an image including at least the specified area with a second resolution, and an image generating system that generates image data corresponding to the image to be acquired by extracting the specified area from an image by the second scanning and reversely rotating the extracted area by the specified angle.

### CROSS-REFERENCE TO RELATED APPLICATION

This application claims priority under 35 U.S.C. §119 from Japanese Patent Application No. 2005-375593, filed on Dec. 27, 2005. The entire subject matter of the application is incorporated herein by reference.

### BACKGROUND

1. Technical Field

The following description relates to one or more techniques for specifying an image area to be scanned on a pre-scanned image to acquire an image in the specified image area in a scanner control program, scanner control device, and scanner device for controlling a scanner device configured to scan an image of an original and transmit the scanned image to an external device.

2. Related Art

An operation of a scanner device connected to a network or a scanner device directly connected to an information processing device such as a personal computer not via the network is generally controlled by a scanner application to be executed by an external information processing device (hereinafter, also referred to as an computer device).

As a scanner application of this kind, there is known an application configured to acquire an image to be scanned in accordance with a procedure in which firstly, an image obtained by a pre-scanning operation with a predetermined low resolution is displayed as a preview image on a display screen of the computer device, and then a user specifies an image area to be scanned on the pre-scanned image, and the specified image area to be scanned is scanned with a predetermined resolution set by the user (e.g., see Japanese Patent Provisional Publication No. HEI 11-275308). In this case, the specifying operation for specifying the image area to be scanned is performed by surrounding a desired image area with a GUI using a rectangular area specifying frame whose dimension can arbitrarily be configured on the display screen.

A scanned image to be outputted from the scanner device is generally an image based on a bit map graphics format such as the PNG, JPEG, GIF, BMP, TIFF, PICT, and the like. The image based on the bit map graphics format is represented with a rectangle of which a crosswise direction and a lengthwise direction are defined as a horizontal direction and a vertical direction on the displayed screen or a printed medium, respectively. For example, the image based on the bit map graphics format has a size of “∘∘ pixels in the crosswise direction×□□ pixels in the lengthwise direction”. Further, in response to the rectangle image based on the bit map graphics format, the scanning operation by the scanner device is, in general, performed in a direction parallel to or perpendicular to a direction in which an original to be scanned has been set. Accordingly, when acquiring the scanned image after specifying a predetermined image area to be scanned on the pre-scanned image as aforementioned, since the acquired image is a rectangle with the lengthwise and crosswise directions predetermined as aforementioned, an image area to be specified by the user is required to be a rectangle with the same lengthwise and crosswise directions. Therefore, the area specifying frame for specifying an image area to be scanned on the pre-scanned image is a rectangle of which each of four sides is parallel to one of the predetermined lengthwise and crosswise directions, respectively (in other words, each of the four sides of the area specifying frame is parallel to a corresponding one of four sides of the pre-scanned image).

However, as shown in FIG. 11A, when the user wishes to acquire an image area tilted with respect to the pre-scanned image thereon as a rectangular image parallel (perpendicular) to the rectangle with the aforementioned predetermined lengthwise and crosswise directions, if the tilted image area is surrounded by the area specifying frame with the aforementioned predetermined lengthwise and crosswise directions, unnecessary portions other than the area that the user wishes to acquire will be included in the specified area. Then, since the scanner device cannot scan the original in a tilted direction, the scanning operation is performed for the specified area including the unnecessary portions. Consequently, as shown in FIG. 11B, the image area that the user wishes to acquire is still tilted, and further the user is caused to acquire a scanned image including the unnecessary portions other than the desired area. In such a case, in order to modify the tilted area to be parallel (perpendicular) to the rectangle with the aforementioned predetermined lengthwise and crosswise directions or acquire only the image in the desired area with the unnecessary portions being excluded, the image acquired through the scanning operation by the scanner device is required to be separately edited with an image editing application. An editing operation with such an image editing application is very complicated and troublesome for the user. In addition, when the user does not own the image editing application, it is impossible to edit the scanned image acquired.

A similar problem is caused when the user wishes to acquire the image of the original in a proper direction thereof in the case where the original has improperly been set at a slant on the scanner device and displayed at a slant on the pre-scanned image.

### SUMMARY

Aspects of the present invention are advantageous in that there can be provided one or more techniques for controlling a scanner device that allows a user to specify an image area to be scanned at a slant with respect to a predetermined reference direction on a pre-scanned image and to acquire an image in the specified area in a manner rotated to be parallel to the reference direction.

### BRIEF DESCRIPTION OF THE ACCOMPANYING DRAWINGS

FIG. 1 is a block diagram showing a schematic configuration of a scanner system in accordance with one or more aspects of the present invention.

FIG. 2 is a flowchart showing a schematic procedure of a whole “scanner control process” to be executed by a CPU of a PC in accordance with one or more aspects of the present invention.

FIG. 3 is a flowchart showing a procedure of a “normal scanning area specifying process” in the “scanner control process” in accordance with one or more aspects of the present invention.

FIG. 4 is a flowchart showing a procedure of a “normal scanned image generating process” in the “scanner control process” in accordance with one or more aspects of the present invention.

FIG. 5 is an example of a screen image displayed on a display portion of the PC (in the case where a main window is displayed) in accordance with one or more aspects of the present invention.

FIG. 6 is an example of a screen image displayed on the display portion of the PC (in the case where a sub window is displayed) in accordance with one or more aspects of the present invention.

FIG. 7 is an example of a screen image displayed on the display portion of the PC (in the case where a rotation angle is specified) in accordance with one or more aspects of the present invention.

FIG. 8A is an example of a screen image displayed on the display portion of the PC (in the case where a normal scanning area is specified) in accordance with one or more aspects of the present invention.

FIG. 8B is an example of an image scanned by a normal scanning operation in accordance with one or more aspects of the present invention.

FIG. 8C is an example of a normal scanned image generated in accordance with one or more aspects of the present invention.

FIG. 9 is an example of a screen image displayed on the display portion of the PC (in the case where an original is scanned at a slant) in accordance with one or more aspects of the present invention.

FIGS. 10A and 10B are examples of respective screen images displayed on the display portion of the PC (in the case where respective rotation angles are directly specified for an area specifying frame) in accordance with another aspect of the present invention.

FIGS. 11A and 11B are illustrations showing a problem in a scanning operation based on a conventional technique.

### DETAILED DESCRIPTION

It is noted that various connections are set forth between elements in the following description. It is noted that these connections in general and, unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

General Overview

According to aspects of the present invention, there is provided a computer-usable medium comprising computer-readable instructions that cause a computer, which includes a display portion configured to display an image thereon and an operating portion through which a specified area on the image displayed on the display portion is designated, to serve as a scanner control device that controls a scanner device, the scanner control device comprising: a first scanning system configured to make the scanner device perform first scanning of an original with a first resolution; a first display system configured to display a first scanned image obtained by the first scanning on a first display area of the display portion; an area specifying frame displaying system configured to display an area specifying frame of a predetermined shape on the display portion in a manner rotated by a rotation angle specified through the operating portion with respect to a predetermined reference direction; an area specifying system configured to specify an area of an image to be acquired from the original on the first scanned image with the area specifying frame displayed by the area specifying frame displaying system; a second scanning system configured to make the scanner device perform second scanning of an image including at least the area specified by the area specifying system with a second resolution; and an image generating system configured to generate image data corresponding to the image to be acquired by extracting the area specified by the area specifying system from a second scanned image obtained by the second scanning and reversely rotating the extracted area by the specified rotation angle.

It is noted that the aforementioned “reference direction” may mean the crosswise direction or the lengthwise direction of the image (namely, the horizontal direction or the vertical direction on the display screen) as already explained, or may mean an arbitrary direction that can define a relative direction with respect to the second scanned image (pre-scanned image). In addition, the area specifying frame is not limited to a rectangle, and may be a circle, an oval, or an arbitrary polygon. However, if the image to be acquired by the scanning is an image based on a format according to which an image is represented as a rectangular image such as an image based on the bit map graphics format, preferably, the area specifying frame may be formed of a rectangle.

According to the computer-usable medium configured as above, it is possible to specify an area tilted with respect to the image by the area specifying frame rotatable by an arbitrary angle. Further, from the image obtained by the second scanning, an image can be generated in a manner rotated such that only the specified area is parallel to the reference direction. Thereby, the area tilted with respect to the first scanned image thereon can be acquired as an image parallel to the reference direction of the image without a complicated operation such as an operation of separately editing the second scanned image using an image editing application.

In addition, even when the original is improperly set at a slant on the scanner device and the original image is displayed at a slant on the first scanned image, it is possible to easily acquire the image properly oriented by specifying the area with the area specifying frame being rotated in conformity to the proper direction of the original.

Optionally, the scanner control device may further comprise a second display system configured to display one of a first scanned image within the area specified by the area specifying frame and a first scanned image in a predetermined area including at least the area specified by the area specifying frame, in a manner reversely rotated by the specified rotation angle, on a second display area of the display portion different from the first display area.

Specifically, for example, in a GUI in a form of a window being displayed, a sub window may be opened in addition to a main window on which the whole first scanned image is displayed. On the sub window, there may be displayed a first scanned image in a range specified by the area specifying frame or a first scanned image in a predetermined area including at least the area specified by the area specifying frame in a manner reversely rotated by the specified rotation angle.

According to the computer-usable medium configured as above, when an area tilted with respect to the first scanned image is specified, in an area (for example, the sub window) other than a display area (for example, the main window) in which the first scanned image has already been displayed, the tilted area specified by the user is displayed in a manner rotated to be parallel to the reference direction of the image. Therefore, it is convenient for the user to check the rotated image actually acquired. In particular, if the computer-usable medium is configured such that the rotated image in the area specified by the user is displayed on the sub window prior to the second scanning is performed by the scanner device, it will be further convenient for the user to confirm what kind of image can be acquired prior to the second scanning is performed by the scanner device.

Optionally, the scanner control device may further comprise a highlighting system configured to highlight the area specified by the area specifying system by changing a display color of an area other than the specified area on the first scanned image displayed on the first display area of the display portion.

Specifically, the area specified by the area specifying frame may be displayed in a relatively emphasized manner with an area other than the specified area being highlighted, with the hue of the area other than the specified area being changed, or with the brightness or chromaticness of the area other than the specified area being decreased.

According to the computer-usable medium configured as above, it is convenient for the user to easily recognize the area specified by the area specifying frame.

Preferably, the second resolution may be higher than the first resolution.

The computer-usable medium as hereinabove explained, for example, may be a magneto-optical disk, CD-ROM, DVD-ROM, hard magnetic disk, ROM, RAM, or the like. Further, with the computer-readable instructions stored therein being loaded into the computer if needed, the functions of the scanner control device provided with the aforementioned systems can be actualized. In other words, according to another aspect of the present invention, there is provided a scanner control device that is connected communicably with a scanner device and configured to control the scanner device, comprising: a display portion configured to display an image thereon; an operating portion through which a specified area on the image displayed on the display portion is designated; a first scanning system configured to make the scanner device perform first scanning of an original with a first resolution; a first display system configured to display a first scanned image obtained by the first scanning on a first display area of the display portion; an area specifying frame displaying system configured to display an area specifying frame of a predetermined shape on the display portion in a manner rotated by a rotation angle specified through the operating portion with respect to a predetermined reference direction; an area specifying system configured to specify an area of an image to be acquired from the original on the first scanned image with the area specifying frame displayed by the area specifying frame displaying system; a second scanning system configured to make the scanner device perform second scanning of an image including at least the area specified by the area specifying system with a second resolution; and an image generating system configured to generate image data corresponding to the image to be acquired by extracting the area specified by the area specifying system from a second scanned image obtained by the second scanning and reversely rotating the extracted area by the specified rotation angle.

The present invention can be applied not only in the case where the scanner device is controlled by the computer connected with the scanner device, but in the case where the scanner device is independently used. Namely, according to a further aspect of the present invention, there is provided a scanner device, which comprises: a display portion configured to display an image thereon; an operating portion through which a specified area on the image displayed on the display portion is designated; a first scanning system configured to perform first scanning of an original with a first resolution; a first display system configured to display a first scanned image obtained by the first scanning on a first display area of the display portion; an area specifying frame displaying system configured to display an area specifying frame of a predetermined shape on the display portion in a manner rotated by a rotation angle specified through the operating portion with respect to a predetermined reference direction; an area specifying system configured to specify an area of an image to be acquired from the original on the first scanned image with the area specifying frame displayed by the area specifying frame displaying system; a second scanning system configured to perform second scanning of an image including at least the area specified by the area specifying system with a second resolution; and an image generating system configured to generate image data corresponding to the image to be acquired by extracting the area specified by the area specifying system from a second scanned image obtained by the second scanning and reversely rotating the extracted area by the specified rotation angle.

As a scanner device to which the scanner device configured as above is suitably applied, there can be cited a so-called multi function center (MFC) provided with a plurality of functions such as a scanner function, printer function, facsimile function, and a copy function. When an image scanned by the scanner function is required to be used for another purpose in the same device as a case where an image scanned by the scanner function is printed by the printer function or is transmitted by the facsimile function in a single MFC, it is convenient that the functions according to the present invention can independently be actualized by the single MFC.

According to a further aspect of the present invention, there is provided a scanner device, which comprises: a scanning unit configured to scan a specified area of an original based on a predetermined direction and generate image data corresponding to the scanned area with the predetermined direction being defined as a reference direction of the image data; an area specifying system configured to specify an area, tilted by a given rotation angle with respect to the predetermined direction, of an image to be acquired from the original; a first control system configured to control the scanning unit to scan an area including the area specified by the area specifying system based on the predetermined direction and generate first image data corresponding to the scanned area including the specified area with the predetermined direction being defined as the reference direction of the first image data; and a converting system configured to convert the first image data into second image data with a direction tilted by the rotation angle being defined as a reference direction of the second image data.

Optionally, the scanner device may further comprise a display portion configured to display an image scanned by the scanning unit thereon, and a second control system configured to control the scanning unit to pre-scan a predetermined area of the original. In this case, the area specifying system may be configured to specify the area of the image to be acquired from the original on the pre-scanned image displayed on the display portion.

Optionally, the converting system may be configured to convert the first image data into second image data corresponding to the image to be acquired with the direction tilted by the rotation angle being defined as the reference direction of the second image data by extracting the area specified by the area specifying system from the first image data.

According to the scanner device configured as above, effects similar to those brought by the aforementioned computer-usable medium, scanner control device, and scanner device can be expected.

Illustrative Aspects

Hereinafter, illustrative aspects according to the present invention will be described with reference to the accompanying drawings. In the aspects, a scanner control program and scanner control device according to the present invention are applied to control of a network scanner. Namely, the aspects make a computer device serve as a scanner control device by incorporating a scanner control program according to the present invention into the computer device.

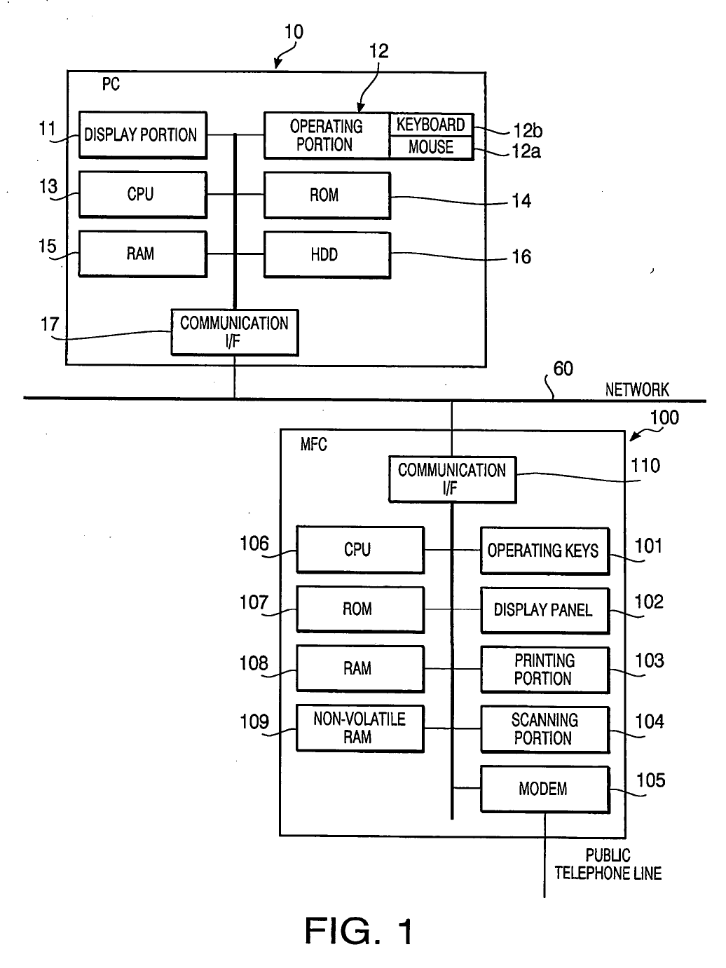

FIG. 1 is a block diagram schematically showing a configuration of a scanner system in which a scanner control device (computer device) 10 according to the present invention is communicably connected with a scanner 100 via a network 60.

Explanation of a Configuration of the Scanner Control Device 10

The scanner control device 10 (hereinafter, referred to as the PC 10) 10 is configured in the same manner as a widely known computer device. Specifically, the PC 10 is provided with a display portion 11 configured with an LCD, and CRT that displays images and characters thereon, an operating portion 12 configured with a mouse 12a as pointing device for pointing a specific part on a display screen of the display portion 11, and a keyboard 12b for inputting characters, a central processing unit (CPU) 13, a read-only semiconductor memory device (ROM) 14, a random accessible semiconductor memory device (RAM) 15, a hard magnetic disk drive (HDD) 16, and a communication interface (communication I/F) 17 for connecting the PC 10 to the network 60. It is noted that the scanner control program according to the present invention is stored in the HDD 16.

Explanation of a Configuration of the Scanner 100

The scanner 100 is a general-purpose multi-function center provided with a so-called printer function and facsimile function as well as a scanner function for computerizing information acquired by scanning an image recorded on a recording medium such as a paper.

The scanner 100 (hereinafter, referred to as an MFC 100) is provided with operating keys 101 for performing various kinds of operations such as an operation of selecting one of the functions provided in the MFC 100, a display panel 102 configured to display the kind of an operation and a task progress thereon, a printing portion 103 configured to print characters or images on a recording medium such as a paper, a scanning portion 104 configured to scan characters or images recorded on a paper or the like and convert the scanned information into digital data, a modem 105 having a function of converting the digital data into a sound signal for facsimile communication to transmit the sound signal to a public telephone line and a function of converting a sound signal for the facsimile communication sent via the public telephone line into digital data, a central processing unit (CPU) 106, a read-only semiconductor memory device (ROM) 107, a random accessible semiconductor memory device (RAM) 108, a random accessible semiconductor memory device (non-volatile RAM) 109 that can keep holding data stored therein even after electrical power supply has been turned off, and a communication interface (communication I/F) 110 for connecting the MFC 100 to the network 60.

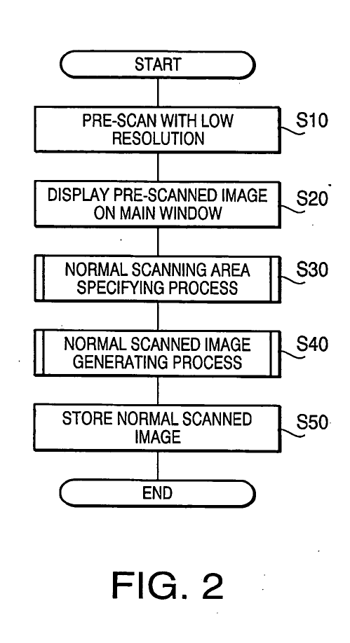

In the scanner system according to the aspects of the present invention, it is possible to pre-scan an original with the scanner function of the MFC 100 on the basis of an operation to be performed by a user with a function of a GUI displayed on the display portion 11 in the PC 10, and to acquire a normal scanned image by scanning over an area specified by the user based on the pre-scanned image. Hereinafter, each of processes to be executed by the PC 10 will be explained in detail with reference to FIGS. 2 to 9. It is noted that hereinafter there will be explained an example case where an OS (operating system) provided with the GUI function is used as an OS of the PC 10.

Explanation of an Overview of a Whole Scanner Control Process

FIG. 2 is a flowchart showing an overview of a whole “scanner control process” to be executed by the CPU 13 of the PC 10. The “scanner control process” is executed when there is inputted by the user via the operating portion 12 an instruction that causes the CPU 13 to acquire the image of the original using the scanner function of the MFC 100.

Firstly, after the original has been set on the scanning portion 104 of the MFC 100, an operation of pre-scanning with a predetermined low resolution is executed by the MFC 100 with an instruction for starting a scanning operation being inputted by the user via the operating portion 12 (S10). At this time, the MFC 100 scans the whole original with the scanning portion 104 to convert the scanned data into digital data based on the control by the PC 10. Then, the scanned digital data are transmitted as a pre-scanned image to the PC 10 via the communication I/F 110.

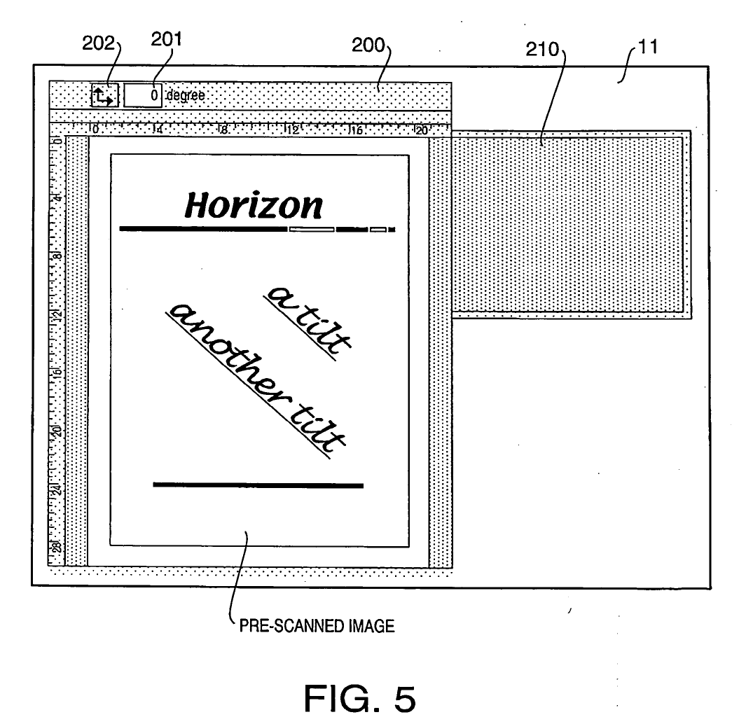

Subsequently, the entire pre-scanned image received from the MFC 100 is displayed as a preview image on a main window 200 (see FIG. 5) displayed as the GUI on the display portion 11 (S20).

FIG. 5 shows the main window 200 and a sub window 210 as the GUI displayed on the display portion 11 at the time when executing the step of S20, and an example of the pre-scanned image. As shown in FIG. 5, in an image display area on the main window 200, there is displayed the entire pre-scanned image. Further, in a toolbar area at an upper portion of the main window 200, there are provided a rotation angle input/display box 201 and a coordinate axes display button 202. On the other hand, nothing is displayed on the sub window 210 at the present time.

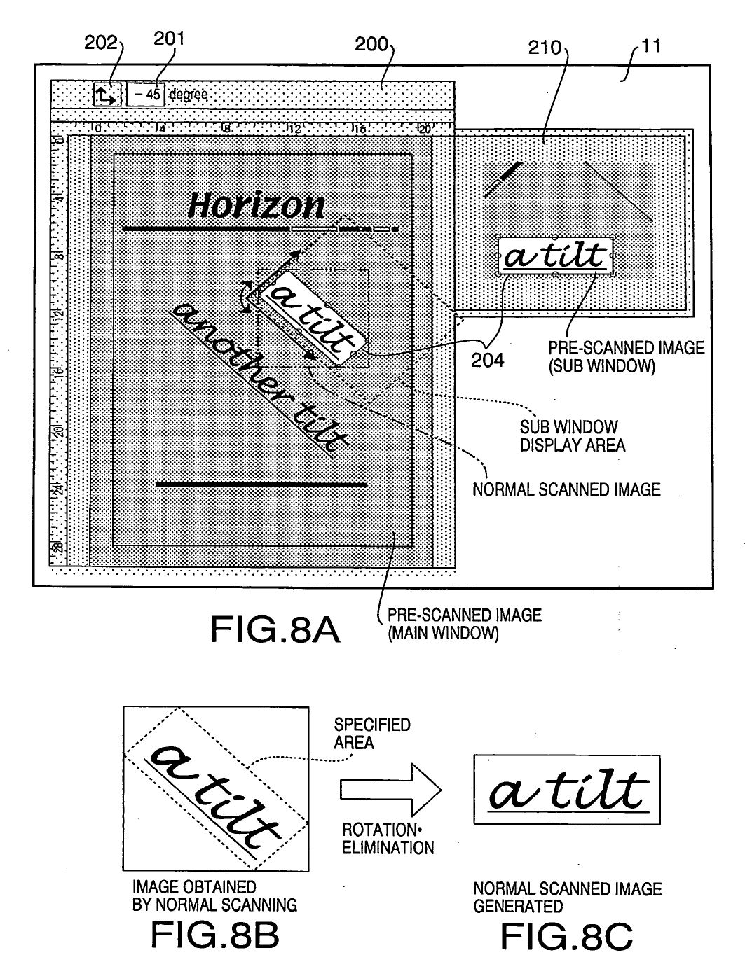

Subsequent explanation of the flowchart in FIG. 2 will be made. In a step of S30, a “normal scanning area specifying process” is executed. The “normal scanning area specifying process” is a process in which the user specifies an area to be acquired as a normal scanned image with a predetermined high resolution based on the pre-scanned images displayed on the main window 200 and sub window 210. In the aspects according to the present invention, it is possible to specify a rectangular area at an arbitrary angle with the pre-scanned image using a rectangular area specifying frame 204 (see FIG. 8A) that is changeable in its size and rotation angle on the display screen of the display portion 11. It is noted that the “normal scanning area specifying process” will be explained in detail below.

Next, in a step of S40, a “normal scanned image generating process” is executed. In the “normal scanned image generating process”, the MFC 100 is assigned to perform the normal scanning over a rectangular area including the area specified by the user in the “normal scanning area specifying process” in S30, and there is generated such a normal scanned image that only the specified area is rotated to be parallel to a reference direction (for example, a lengthwise direction or a crosswise direction of the image of the original, namely, a vertical direction or a horizontal direction on the display screen of the display portion 11) by giving image processing (such as a rotating operation and eliminating operation) for the scanned image acquired by the normal scanning. It is noted that the “normal scanned image generating process” will be explained in detail below.

Then, the normal scanned image generated in the “normal scanned image generating process” in S40 is stored in a predetermined memory area of the HDD 16 with a file name specified by the user or automatically specified (S50).

Explanation of the Normal Scanning Area Specifying Process

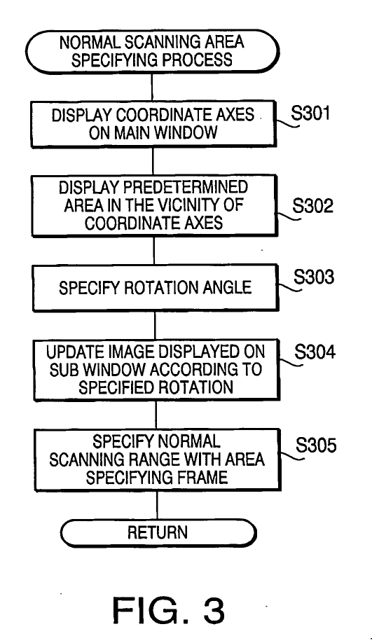

FIG. 3 is a flowchart showing a procedure of the “normal scanning area specifying process” in S30 in the “scanner control process” (see FIG. 2).

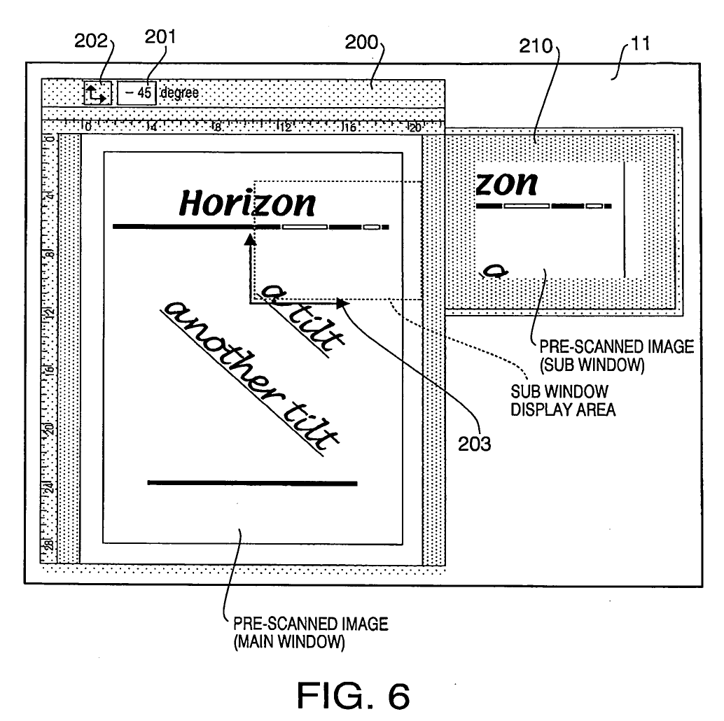

Firstly, a pointer (not shown) on the display screen of the display portion 11 is operated by the user via the mouse 12a, and the coordinate axes display button 202 provided in the toolbar area at the upper portion of the main window 200 is clicked. Thereby, the coordinate axes are displayed on the main window 200 (S301). FIG. 6 shows a state where the coordinate axes are displayed on the main window 200. As shown in FIG. 6, an image in a predetermined area in the vicinity of the coordinate axes displayed is displayed on the sub window 210 (S302).

Here, functions of the coordinate axes 203 and sub window 210 will be explained on the basis of FIG. 6. The coordinate axes 203 serve as an icon for intelligibly showing, for the user, a currently configured rotation angle of the area specifying frame 204 (which will be described in detail below) for specifying an area of an image to be acquired on the pre-scanned image. The coordinate axes 203 are displayed in a predetermined position in a default state with a rotation angle of 0 degrees. From the default state, the coordinate axes 203 can be rotated around the origin thereof by an arbitrary angle and/or shifted by a dragging operation with the mouse 12a. The state with a rotation angle of 0 degrees is a state of being parallel to the reference direction of the image. When expanding the area specifying frame 204 in the state, the area specifying frame 204 is a rectangle parallel to the reference direction of the image along directions shown by the displayed coordinate axes 203 (in other words, a rectangle of which each of four sides is parallel to a corresponding one of four sides of the pre-scanned image). It is noted that the rotation angle of the coordinate axes 203 is displayed in the rotation angle input/display box 201 provided in the toolbar area at the upper portion of the main window 200.

In the sub window 210, there is displayed the pre-scanned image in a sub window display area (an area in a rectangular frame (not shown in an actual case) shown by a dashed line in FIG. 6) that is a predetermined rectangular area along the directions shown by the coordinate axes 203. The sub window display area is rotated around the origin of the coordinate axes 203 by a configured rotation angle on the main window 200. However, on the sub window 210, there is displayed an image obtained by rotating the image in the sub window display area by the configured rotation angle in the reverse direction. Namely, in the sub window 210, regardless of the configured rotation angle, there is always displayed the image in the sub window display area in a manner parallel to the reference direction of the image.

Subsequent explanation of the flowchart in FIG. 3 will be made. In a step of S303, an input operation by the user for specifying the rotation angle of the coordinate axes 203 is accepted via the operating portion 12, and the coordinate axes 203 are rotated based on the input operation. Specifically, the coordinate axes 203 are directly dragged by the pointer through the mouse 12a to be rotated, or a numerical value of the rotation angle is directly inputted into the rotation angle input/display box 201 via the keyboard 12b after the rotation angle input/display box 201 is clicked by the pointer, so as to specify the rotation angle.

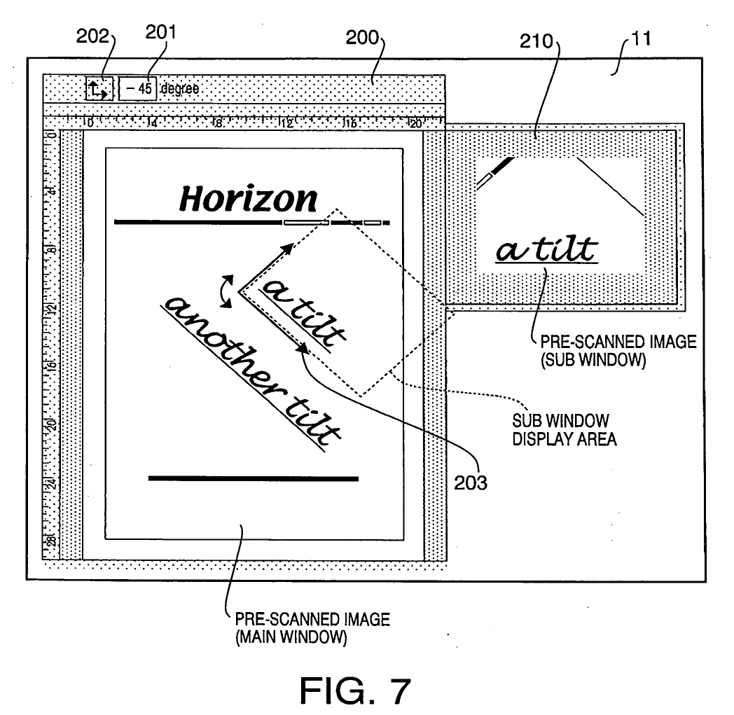

Next, according to the rotation angle specified in S303, the image displayed on the sub window 210 is updated with the image in the sub window display area after the rotation. At this time, regardless of the rotation angle of the sub window display area, there is always displayed in the sub window 210 the image in the sub window display area in a manner parallel to the reference direction of the image. In FIG. 7, there is shown a state where, with the rotation angle of the coordinate axes 203 being specified (S303), the rotated coordinate axes 203 are displayed on the main window 200, and the image displayed on the sub window 210 is updated (S304).

FIG. 7 shows a screen display example in the case where the rotation angle of the coordinate axes 203 is set to be −45 degrees. As shown in FIG. 7, with the rotation angle being set to be −45 degrees, the coordinate axes are rotated by −45 degrees, and accompanied by it, the sub window display area is rotated by −45 degrees. On the other hand, in the sub window 210, there is displayed the image in the sub window display area in a manner rotated by the set rotation angle in the reverse direction (namely, +45 degrees). In other words, in the sub window 210, the image in the sub window display area is displayed in a manner parallel to the reference direction of the image.

Subsequent explanation of the flowchart in FIG. 3 will be made. After the image displayed on the sub window 210 has been updated in S304, an input operation for specifying the area of the normal scanned image to be acquired on the display screen of the display portion 11 with the rectangular area specifying frame as the GUI is accepted (S305), and then the “normal scanning area specifying process” is terminated. Specifically, the area of the normal scanned image to be acquired is specified by expanding the area specifying frame 204 from an arbitrary starting point to a desired size by a dragging operation with the mouse on the pre-scanned image displayed on the sub window 210. At this time, the area specifying frame 204 is expanded along directions corresponding to the rotation angle specified in S303 (namely, along directions indicated by the coordinate axes 203). In addition, the area specified by the area specifying frame 204 is displayed in the pre-scanned images on both of the main window 200 and sub window 210 (see FIG. 8A).

It is noted that the operation for expanding the area specifying frame 204 with the mouse 12a may is performed on the pre-scanned image on the main window 200. In this case, for example, the starting point of the area specifying frame 204 may be fixed in the vicinity of the origin of the coordinate axes 203 displayed on the main window 200, and expanded along the directions indicated by the coordinate axes 203 to an arbitrary size corresponding to the operation amount of the mouse 12a. Further, an area specifying frame 204 corresponding thereto may be displayed on the sub window 210 as well.

FIG. 8A is an example of a screen display in the case where the area of the normal scanned image to be acquired is specified by the area specifying frame 204. As shown in FIG. 8A, in the pre-scanned image on each of the main window 200 and sub window 210, a portion of the image is surrounded by the area specifying frame 204. The area surrounded by the area specifying frame 204 corresponds to the normal scanned image to be acquired. It is noted that, in the screen display example, since the rotation angle is set to be −45 degrees, the area specifying frame 204 is displayed in a manner rotated by an angle of −45 degrees with respect to the reference direction. In the meantime, since the pre-scanned image on the sub window 210 is obtained by rotating the image in the sub window display area by the set rotation angle (+45 degrees) in the reverse direction, the area specifying frame 204 to be displayed in the sub window 210 is always displayed in a manner parallel to the reference direction of the image regardless of the specified rotation angle. Further, at this time, in the pre-scanned image displayed on each of the main window 200 and sub window 210, the specified area surrounded by the area specifying frame 204 is highlighted by darkly displaying an area other than the specified area.

Explanation of the Normal Scanned Image Generating Process

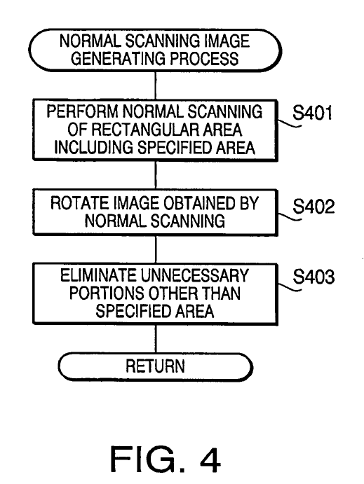

FIG. 4 is a flowchart showing a procedure of the “normal scanned image generating process” in S40 to be executed in the “scanner control process” (see FIG. 2).

Firstly, after the area of the normal scanned image to be acquired has been specified by the user in the aforementioned “normal scanned area specifying process” (see FIG. 3), when an instruction for performing the normal scanning is inputted by the user through the operating portion 12, a normal scanning area as a rectangular area including the specified area is set, and the MFC 100 is caused to perform the normal scanning based on the set normal scanning area (S401). The normal scanning, unlike the pre-scanning with a low resolution, is performed with a high resolution set by the user. At this time, based on the control from the PC 10, the MFC 100 scans a portion corresponding to the normal scanning area of the original as set with the scanning portion 104, and converts the scanned information into the digital data. Then, the scanned digital data is transmitted as a scanned image by the normal scanning to the PC 10 via the communication I/F 110.

An operation of scanning an original by a scanner is generally performed in the horizontal or vertical direction with respect to a direction in which the original has been set, and cannot be performed in a tilted direction. In view of such a situation, the normal scanning area set in S401 is set to be a rectangular area parallel to the reference direction of the image, as shown by a chain double dashed line in FIG. 8A, which includes the area specified by the area specifying frame 204. When the area specified by the area specifying frame 204 is at a slant with respect to the reference direction of the image, the scanned image by the normal scanning, as shown in FIG. 8B, includes unnecessary areas other than the specified area, and the specified area (the area of the image to be acquired) is still at a slant.

Therefore, firstly, in a step of S402, the scanned image by the normal scanning is rotated by the rotation angle specified in S303 (see FIG. 3) in the reverse direction (S402). In the example shown in FIG. 8A, since the specified rotation angle is −45 degrees, the scanned image is rotated by an angle of +45 degrees. Then, by eliminating the unnecessary portions other than the specified area, the normal scanned image as shown in FIG. 8C can be obtained (S403).

Effects

According to the scanner system in the aspects, following effects can be expected. On the display screen of the display portion 11 of the PC 10, it is possible to specify the area of the normal scanned image to be acquired in a manner tilted with respect to the reference direction of the image with the area specifying frame 204 rotatable at an arbitrary angle. Further, it is possible to extract only the specified area from the scanned image obtained by the normal scanning by the MFC 100, and to generate the normal scanned image by rotating the image in the extracted area to be parallel to the reference direction of the image. Thereby, the area tilted with respect to the pre-scanned image thereon can be acquired as an image parallel to the reference direction of the image without a complicated operation such as an operation of separately editing the normal scanned image using an image editing application.

Further, it is possible to display a predetermined area (sub window display area) in the vicinity of the coordinate axes 203 displayed on the main window 200 and the pre-scanned image in the area specified by the area specifying frame 204 in a manner rotated by the specified rotation angle in the reverse direction on the sub window 210, Thereby, the scanner system is so convenient that the user can specify the area of the image to be acquired as confirming the direction of the actually obtained image and check what kind of image is obtained by the normal scanning prior to the normal scanning.

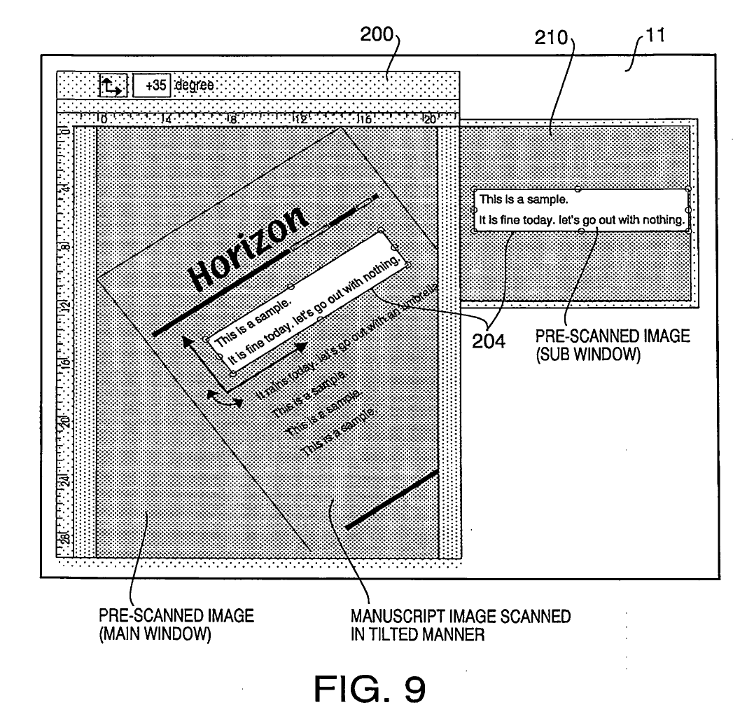

In addition, as shown in FIG. 9, even when the original is improperly set at a slant on the scanning portion 104 of the MFC 100 and the image of the original is displayed at a slant on the pre-scanned image on the main window 200, it is possible to easily acquire the image properly oriented by specifying the area with the area specifying frame 204 being rotated in conformity to the proper direction of the original. At this time, since the image in the specified area is displayed in a manner rotated to be parallel to the reference direction of the image on the sub window 210, the scanner system is convenient in that the user can confirm the image modified to be properly oriented.

In addition, after the user has specified the area of the normal scanned image to be acquired with the area specifying frame 204, the specified area is highlighted by darkly displaying a portion other than the specified area in the pre-scanned image. Therefore, the scanner system is convenient in that the user can more easily recognize the specified area.

Modifications

Hereinabove, the illustrative aspects according to the present invention have been described. However, the present invention is not limited to the aforementioned illustrative aspects, and various sorts of modifications may be possible as far as they are within a technical scope which does not extend beyond a subject matter of the present invention.

For example, the sub window display area (indicated by a dashed line in FIG. 6) accompanied by the coordinate axes 203 may be configured such that the size thereof can be changed by an instruction from the user. At this time, in response to the size of the sub window display area, the display area may be changed by changing a display magnification of the image on the sub window 210 or changing the size of the sub window 210.

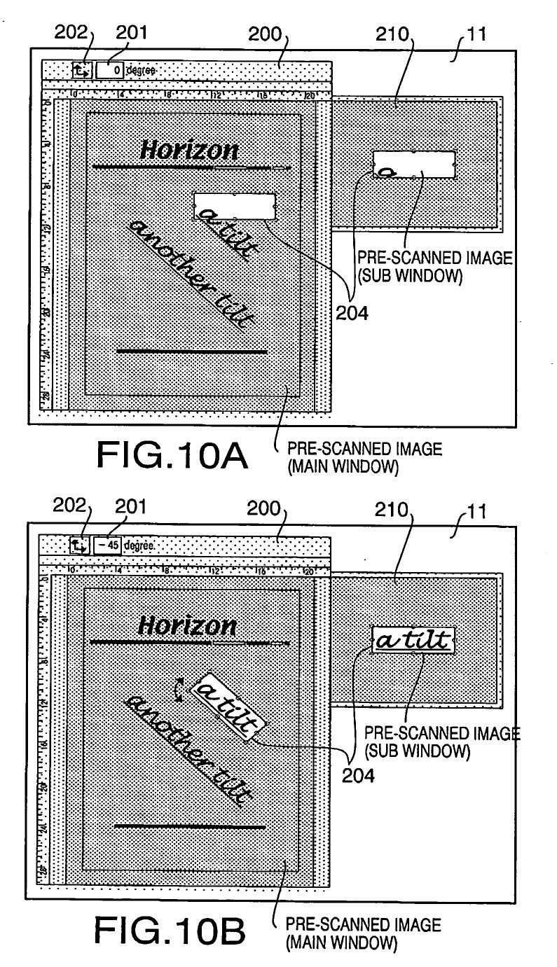

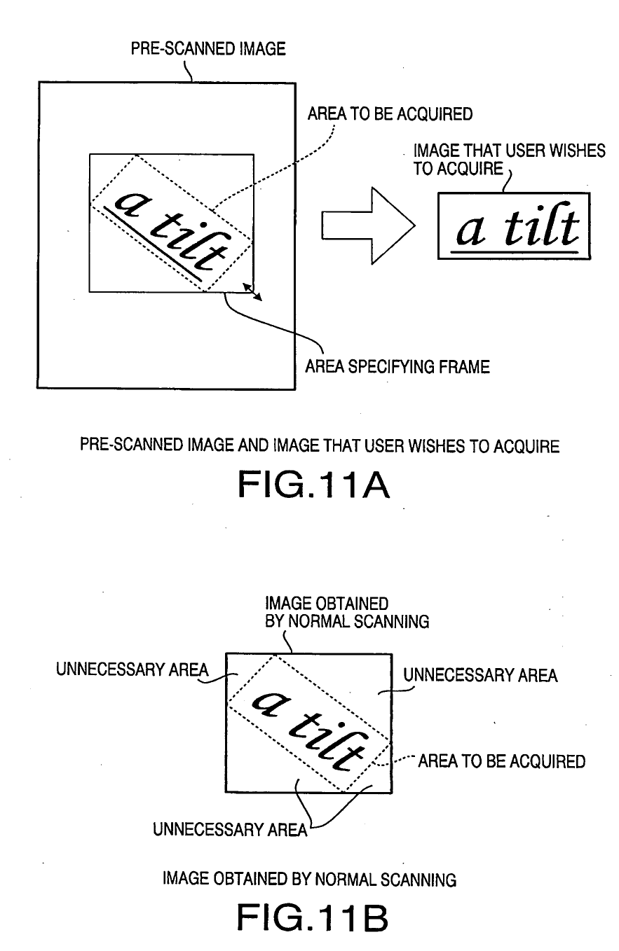

In addition, the operations of displaying the coordinate axes 203 in the steps of S301 and S302 of the aforementioned “normal scanning area specifying process” may be omitted, and as shown in FIG. 10A, after the area specifying frame 204 for specifying the area of the normal scanned image to be acquired has been displayed, the rotation angle for the area specifying frame 204 may be specified directly by a dragging operation with the mouse 12a or a numerical value inputted through the keyboard 12b (see FIG. 10B). At this time, on the sub window 210, there may be displayed only the image in the area specified by the area specifying frame 204 as shown in FIGS. 10A and 10B or an image in a predetermined area centering on the specified area.

In the aforementioned illustrative aspects, the scanner control program and scanner control device according to the present invention are applied to the control of the network scanner. Namely, with the scanner control program according to the present invention being installed into the PC 10, the PC 10 is caused to serve as the scanner control device in the aforementioned illustrative aspects. However, a technical thought of the present invention can be applied not only in the case where the MFC 100 is controlled from the PC 10 connected with the MFC 100 via the network 60 as the above illustrative aspects, but also in the case where the MFC 100 is independently used. Specifically, with a program having the same function as the scanner control program incorporated into the PC 10 being stored into the ROM 107 or non-volatile RAM 109 of the MFC 100, the same function as the above illustrative aspects can be actualized in the MFC 100.

Therefore, when the image scanned by the scanner function is likely to be used for other purposes by the same device as the MFC 100 in the illustrative aspects that can print the image scanned by the scanner function by the printer function or facsimile the scanned image by the facsimile function in the single multi-function center, it is convenient that the functions according to the present invention can independently be actualized in the single multi-function center.

The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without resorting to the details specifically set forth. In other instances, well known processing structures have not been described in detail, in order not to unnecessarily obscure the present invention.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

What is claimed is:

1. A computer-usable medium comprising computer-readable instructions that cause a computer, which includes a display portion configured to display an image thereon and an operating portion through which a specified area on the image displayed on the display portion is designated, to serve as a scanner control device that controls a scanner device, the scanner control device comprising:
a first scanning system configured to make the scanner device perform first scanning of an original with a first resolution;
a first display system configured to display a first scanned image obtained by the first scanning on a first display area of the display portion;
an area specifying frame displaying system configured to display an area specifying frame of a predetermined shape on the display portion in a manner rotated by a rotation angle specified through the operating portion with respect to a predetermined reference direction;
an area specifying system configured to specify an area of an image to be acquired from the original on the first scanned image with the area specifying frame displayed by the area specifying frame displaying system;
a second scanning system configured to make the scanner device perform second scanning of an image including at least the area specified by the area specifying system with a second resolution; and
an image generating system configured to generate image data corresponding to the image to be acquired by extracting the area specified by the area specifying system from a second scanned image obtained by the second scanning and reversely rotating the extracted area by the specified rotation angle.

2. The computer-usable medium according to claim 1,
wherein the area specifying frame is formed of a rectangle.

3. The computer-usable medium according to claim 1,
wherein the scanner control device further comprises a second display system configured to display one of a first scanned image within the area specified by the area specifying frame and a first scanned image in a predetermined area including at least the area specified by the area specifying frame, in a manner reversely rotated by the specified rotation angle, on a second display area of the display portion different from the first display area.

4. The computer-usable medium according to claim 1,
wherein the scanner control device further comprises a highlighting system configured to highlight the area specified by the area specifying system by changing a display color of an area other than the specified area on the first scanned image displayed on the first display area of the display portion.

5. The computer-usable medium according to claim 1,
wherein the second resolution is higher than the first resolution.

6. A scanner control device that is connected communicably with a scanner device and configured to control the scanner device, comprising:
a display portion configured to display an image thereon;
an operating portion through which a specified area on the image displayed on the display portion is designated;
a first scanning system configured to make the scanner device perform first scanning of an original with a first resolution;
a first display system configured to display a first scanned image obtained by the first scanning on a first display area of the display portion;
an area specifying frame displaying system configured to display an area specifying frame of a predetermined shape on the display portion in a manner rotated by a rotation angle specified through the operating portion with respect to a predetermined reference direction;
an area specifying system configured to specify an area of an image to be acquired from the original on the first scanned image with the area specifying frame displayed by the area specifying frame displaying system;
a second scanning system configured to make the scanner device perform second scanning of an image including at least the area specified by the area specifying system with a second resolution; and
an image generating system configured to generate image data corresponding to the image to be acquired by extracting the area specified by the area specifying system from a second scanned image obtained by the second scanning and reversely rotating the extracted area by the specified rotation angle.

7. The scanner control device according to claim 6,
wherein the area specifying frame is formed of a rectangle.

8. The scanner control device according to claim 6, further comprising a second display system configured to display one of a first scanned image within the area specified by the area specifying frame and a first scanned image in a predetermined area including at least the area specified by the area specifying frame, in a manner reversely rotated by the specified rotation angle, on a second display area of the display portion different from the first display area.

9. The scanner control device according to claim 6, further comprising a highlighting system configured to highlight the area specified by the area specifying system by changing a display color of an area other than the specified area on the first scanned image displayed on the first display area of the display portion.

10. The scanner control device according to claim 6,
wherein the second resolution is higher than the first resolution.

11. A scanner device, comprising:
a display portion configured to display an image thereon;
an operating portion through which a specified area on the image displayed on the display portion is designated;
a first scanning system configured to perform first scanning of an original with a first resolution;
a first display system configured to display a first scanned image obtained by the first scanning on a first display area of the display portion;
an area specifying frame displaying system configured to display an area specifying frame of a predetermined shape on the display portion in a manner rotated by a rotation angle specified through the operating portion with respect to a predetermined reference direction;
an area specifying system configured to specify an area of an image to be acquired from the original on the first scanned image with the area specifying frame displayed by the area specifying frame displaying system;
a second scanning system configured to perform second scanning of an image including at least the area specified by the area specifying system with a second resolution; and
an image generating system configured to generate image data corresponding to the image to be acquired by extracting the area specified by the area specifying system from a second scanned image obtained by the second scanning and reversely rotating the extracted area by the specified rotation angle.

12. The scanner device according to claim 11,
wherein the area specifying frame is formed of a rectangle.

13. The scanner device according to claim 11, further comprising a second display system configured to display one of a first scanned image within the area specified by the area specifying frame and a first scanned image in a predetermined area including at least the area specified by the area specifying frame, in a manner reversely rotated by the specified rotation angle, on a second display area of the display portion different from the first display area.

14. The scanner device according to claim 1, further comprising a highlighting system configured to highlight the area specified by the area specifying system by changing a display color of an area other than the specified area on the first scanned image displayed on the first display area of the display portion.

15. The scanner device according to claim 1,
wherein the second resolution is higher than the first resolution.

16. A scanner device, comprising:
a scanning unit configured to scan a specified area of an original based on a predetermined direction and generate image data corresponding to the scanned area with the predetermined direction being defined as a reference direction of the image data;
an area specifying system configured to specify an area, tilted by a given rotation angle with respect to the predetermined direction, of an image to be acquired from the original;
a first control system configured to control the scanning unit to scan an area including the area specified by the area specifying system based on the predetermined direction and generate first image data corresponding to the scanned area including the specified area with the predetermined direction being defined as the reference direction of the first image data; and
a converting system configured to convert the first image data into second image data with a direction tilted by the rotation angle being defined as a reference direction of the second image data.

17. The scanner device according to claim 16, further comprising:
a display portion configured to display an image scanned by the scanning unit thereon; and
a second control system configured to control the scanning unit to pre-scan a predetermined area of the original,
wherein the area specifying system is configured to specify the area of the image to be acquired from the original on the pre-scanned image displayed on the display portion.

18. The scanner device according to claim 16,
wherein the converting system is configured to convert the first image data into second image data corresponding to the image to be acquired with the direction tilted by the rotation angle being defined as the reference direction of the second image data by extracting the area specified by the area specifying system from the first image data.
